(19) United States
(12) Patent Application Publication
(10) Pub. No.: US 2016/0125473 A1
(43) Pub. Date: May 5, 2016

(54) TARGETED ADVERTISING BASED ON CHANGES IN PHYSICAL ATTRIBUTES

(71) Applicant: TOSHIBA GLOBAL COMMERCE SOLUTIONS HOLDINGS CORPORATION, Tokyo (JP)

(72) Inventor: Ankit SINGH, Morrisville, NC (US)

(21) Appl. No.: 14/529,448

(22) Filed: Oct. 31, 2014

(51) Int. Cl. G06Q 30/02; G06K 9/00

(52) U.S. Cl. CPC G06Q 30/0271; G06K 9/00281; G06K 9/00369

(57) ABSTRACT

Systems, methods, and computer program products to perform image analysis of a first image and a second image by comparing a first physical trait of a person in the first image to the first physical trait of the person in the second image, wherein the first image was taken earlier in time than the second image, and detecting, based on the comparison, a change in the first physical trait of the person, and preparing a targeted advertisement directed to the person based on the change in the first physical trait.

### BACKGROUND

The present disclosure relates to computer software, and more specifically, to computer software to provide targeted advertising based on changes in physical attributes.

Currently, retailers may advertise electronically using email or traditional mail for new products, specials, or other reasons. The advertisements typically are received by all customers, even though the products or services in the advertisements may not appeal to each customer. In the long run, users may lose interest if the advertisements are not targeted at them.

### SUMMARY

Aspects disclosed herein include systems, methods, and computer program products to perform image analysis of a first image and a second image by comparing a first physical trait of a person in the first image to the first physical trait of the person in the second image, wherein the first image was taken earlier in time than the second image, and detecting, based on the comparison, a change in the first physical trait of the person, and preparing a targeted advertisement directed to the person based on the change in the first physical trait.

### BRIEF DESCRIPTION OF THE SEVERAL VIEWS OF THE DRAWINGS

FIGS. 1A-1B illustrate techniques to provide targeted advertising based on changes in physical attributes, according to one aspect.

FIG. 2 illustrates a system to provide targeted advertising based on changes in physical attributes, according to one aspect.

FIG. 3 illustrates a method to provide targeted advertising based on changes in physical attributes, according to one aspect.

FIG. 4 illustrates a method to detect changes in physical attributes, according to one aspect.

FIG. 5 illustrates components of an advertisement application, according to one aspect.

### DETAILED DESCRIPTION

Aspects disclosed herein provide targeted advertising to customers based on changes in the customers' physical attributes. The changes in a customer's physical attributes may be based on a comparison of images of the customer taken at different times. For example, a first photo of a customer may be taken at the checkout line of a retail store. Six months later, a second photo of the customer may be taken in the retail store (or uploaded by the user from an online interface). Once two or more photos of the customer are available, a comparison of the images (or attributes extracted therefrom) may be performed in order to detect changes in the customer's physical attributes. For example, the comparison may determine that the customer's teeth have become more yellow or stained in the second picture relative to the first picture. Upon making this determination, advertisements for products to help the customer whiten their teeth may be sent to the user.

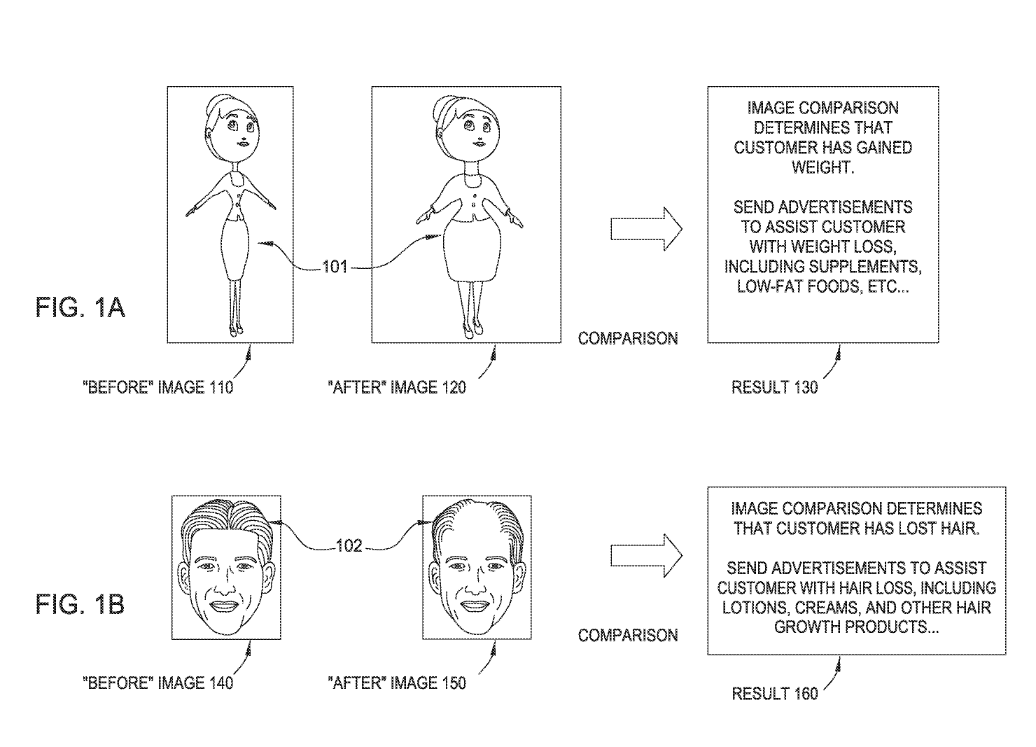

FIG. 1A illustrates techniques to provide targeted advertising based on changes in physical attributes, according to one aspect. As shown, FIG. 1A depicts two photos of a customer 101, including a “before” image 110, and an “after” image 120. The images 110, 120 of the customer 101 may be taken by any means. For example, the images 110, 120 may be taken at a checkout lane (or a self-checkout lane) of a retail store. Similarly, users may periodically upload photos of themselves through an online portal for customer loyalty programs. Regardless of the mode of capture, the images 110, 120 may be stored as part of the customer's profile in a customer loyalty program database. In some aspects, photographs of the customer may be periodically captured according to a timing schedule. For example, the photographs may be taken at one month, 3 month, 6 month, 9 month, or 12 month intervals.

As shown, the customer 101 is thin in the “before” image 110, but overweight in the “after” image 120. Aspects disclosed herein may analyze each image 110, 120 at the time of capture in order to extract physical attributes of the customer 101 from the images. For example, the customer's body fat may be estimated based on each image. Relative to image 110, aspects may estimate that the customer 101 has a body fat of 2%, and store this estimated body fat in the customer's profile (along with other extracted physical attributes). Relative to image 120, aspects may estimate that the customer 101 now has a body fat of 20%, and store this estimated body fat in the customer's profile (along with other extracted physical attributes). Aspects may then compare the extracted physical attributes and determine that a change in the customer's physical appearance has occurred. For example, aspects may identify the 18% difference in body fat from the “after” image 120 relative to the “before” image 110 as a change. In some aspects, this change may be compared to a threshold value before determining that a change of sufficient magnitude has occurred. For example, the body fat percentage change threshold may be 5%, such that any body fat change greater than or equal to 5 percentage points may be considered a change in physical appearance. Once the change is detected, aspects may select from a set of products and/or services associated with weight loss. Therefore, as shown in the comparison result 130, the image comparison has determined that the customer 101 has gained weight. As such, aspects may send advertisements to the customer 101 to assist the customer 101 with weight loss, such as supplements, low-fat foods, and the like. Aspects may further store this change in physical appearance in the customer profile. The targeted advertisements to help the customer lose weight may be sent by any medium, including without limitation email, traditional mail, text message, multimedia message, social media messaging, targeted social media broadcasts, and the like.

FIG. 1B illustrates techniques to provide targeted advertising based on changes in physical attributes, according to one aspect. As shown, FIG. 1B depicts a “before” image 140 and an “after” image 150 of a customer 102. The “before” image 140 may be taken when the customer registers for a loyalty program, while the “after” image 150 may be taken six months later, when the customer is in the retail store. Generally, aspects may request to take photos of customers at periodic intervals in order to detect changes in the customers' physical attributes.

As shown, the customer 102 has a full head of hair in image 140, while in image 150, the customer has lost some of his hair. As part of the image capture and storage process, aspects may extract these features from the photos and store them in the user profile for customer 102. For example, aspects may determine that the customer 102 has a full head of hair by analyzing the image, and store an indication that the customer 102 has a full head of hair in the customer profile when the “before” image 140 is taken. Six months later when the “after” image 150 is taken, aspects may determine that the customer 102 has lost some hair, and store an indication that the customer 102 has lost hair in the profile for customer 102. By comparing these two indications, aspects may determine a change in the physical appearance of customer 102, and select a targeted advertisement for the customer based on the change. For example, as shown in the comparison result 160, the system has determined that the customer has lost hair, and determines to send advertisements to the customer 102 that assist people with hair loss, such as lotions, creams, or other hair growth products. Furthermore, because the advertisements are selected based on changes in physical attributes, and not physical attributes at the current time, a person who was bald in both the “before” and “after” images may not be offered advertisements for hair growth products.

In some aspects, instead of sending the advertisement directly to the customer, the advertisement may be introduced into the general environment proximate the customer, i.e., on an electronic billboard, computer monitor, television, and the like. Further still, the advertisements may be integrated into the websites being visited by the customer. Stated differently, the advertisements may be delivered to the customer in any number of ways.

While FIGS. 1A-1B are discussed with reference to extracting attributes from each image, in some aspects, a comparison of each image using comparison techniques may be performed in order to identify changes in physical attributes. Furthermore, although weight gain and hair loss are depicted as examples in FIGS. 1A-1B, aspects may generally detect any quantifiable change in a person's appearance. Any such examples should not be considered limiting of the disclosure. For example, if customer 102 was wearing glasses in image 150, but did not have them in image 140 (or other images of the user taken prior to the image 150), aspects may detect the eyeglasses and offer contact lenses, specialty glasses, or other eye health products in an advertisement targeted to the customer 102.

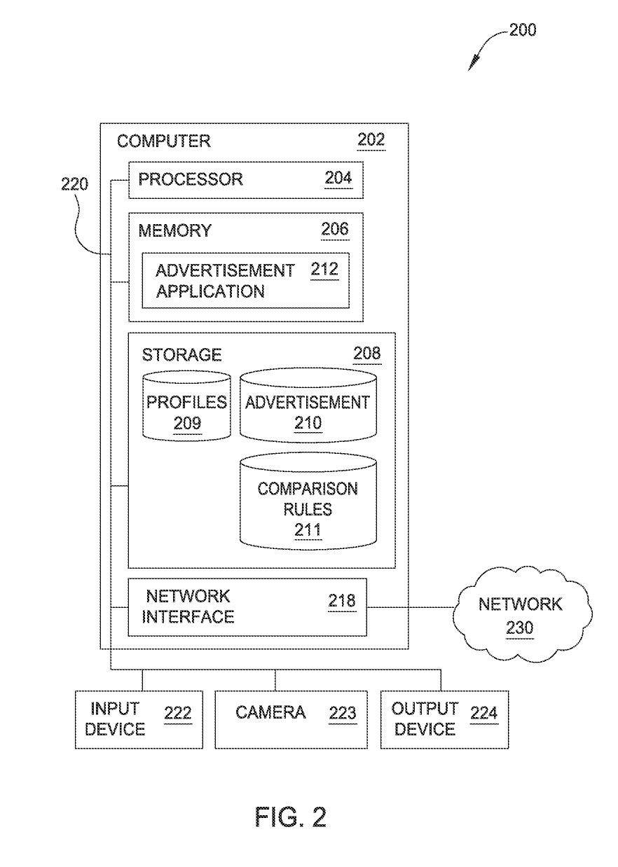

FIG. 2 illustrates a system 200 to provide targeted advertising based on changes in physical attributes, according to one aspect. The networked system 200 includes a computer 202. The computer 202 may also be connected to other computers via a network 230. In general, the network 230 may be a telecommunications network and/or a wide area network (WAN). In a particular embodiment, the network 230 is the Internet. In one embodiment, the computer 202 is part of a checkout lane (or self-checkout lane) in a retail store.

The computer 202 generally includes a processor 204 connected via a bus 220 to a memory 206, a network interface device 218, a storage 208, an input device 222, and an output device 224. The computer 202 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 204 is included to be representative of a single CPU, multiple CPUs, a single CPU having multiple processing cores, and the like. The network interface device 218 may be any type of network communications device allowing the computer 202 to communicate with other computers via the network 230.

The storage 208 may be a persistent storage device. Although the storage 208 is shown as a single unit, the storage 208 may be a combination of fixed and/or removable storage devices, such as fixed disc drives, solid state drives, SAN storage, NAS storage, removable memory cards or optical storage. The memory 206 and the storage 208 may be part of one virtual address space spanning multiple primary and secondary storage devices.

The input device 222 may be any device for providing input to the computer 202. For example, a keyboard and/or a mouse may be used. The output device 224 may be any device for providing output to a user of the computer 202. For example, the output device 224 may be any conventional display screen or set of speakers. Although shown separately from the input device 222, the output device 224 and input device 222 may be combined. For example, a display screen with an integrated touch-screen may be used. The camera 223 may be any camera configured to capture an image of a user.

As shown, the memory 206 contains the advertisement application 212, which is an application generally configured to provide targeted advertisements based on changes in a person's physical attributes. Generally, the advertisement application 212 may extract values for physical attributes from photos of a person, and store those extracted values in a user profile for the user in the profiles 209. At a later date (for example, according to a predefined photograph request schedule), the user may be asked to take another photo of themselves, such as in a retail store checkout lane, or by providing a recent image of their own. The advertisement application 212 may then extract updated values for the physical attributes, and store the updated values in the user's profile in the profiles 209. The advertisement application 212 may then compare the sets of extracted values in order to determine if the user's physical appearance has changed in any way. Once the advertisement application 212 determines that the user's physical attributes have changed, the advertisement application 212 may select advertisements that are related to the change in physical attributes, and transmit the advertisements to the user. For example, if a female customer's stomach region shows signs of pregnancy in a newly captured photo, and an older photo does not reflect an enlarged stomach region, the advertisement application 212 may determine that the customer is pregnant, and send the customer advertisements for baby products. In one aspect, the advertisement application 212 may select existing advertisements from the advertisements 210. In another aspect, the advertisement application 212 may generate an advertisement in real time, where the advertisement is based on the detected change in physical attribute. In addition to extracting values, the advertisement application 212 may perform an image comparison of two photos of the user in order to detect changes in the user's physical appearance. The advertisement application 212 may further store indications of the change in physical appearance in the profiles 209.

As shown, storage 208 contains the profiles 209, advertisements 210, and comparison rules 211. The profiles 209 are configured to store user profile data for a plurality of users. In at least one aspect, the profiles 209 are part of a loyalty rewards program provided by a retailer or other merchant. In addition to different biographic/contact information about the user, the profiles 209 are configured to store images of the user, as well as indications of physical attributes of the user. For example, the advertisement application 212 may analyze a first image of a user, and determine that the user has 10% body fat, has black hair, and healthy skin. The advertisement application 212 may then store indications (or values) to reflect these attributes in the user's profile in the profiles 209.

The advertisements 210 are generally configured to store advertisements for different products and/or services, as well as associations between the products and/or services and changes in physical attributes. For example, hair color products may be associated with men whose hair color has turned gray. The comparison rules 211 specify a set of rules to determine whether a change in physical appearance has occurred. For example, user's teeth coloration may be represented by red green blue (RGB) intensity values in the profiles 209. The comparison rules 211 may specify a threshold change in RGB values in order for the advertisement application 212 to determine that the user's teeth color has changed to the point that a targeted advertisement for teeth whitening products should be sent to the user. Generally, the comparison rules 211 may include rules for any physical attribute.

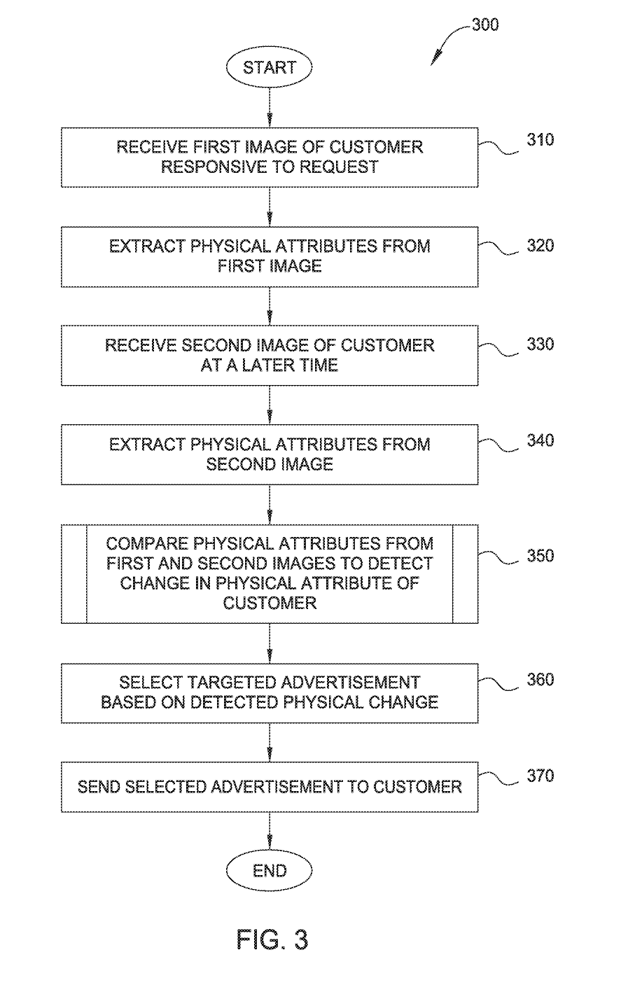

FIG. 3 illustrates a method 300 to provide targeted advertising based on changes in physical attributes, according to one aspect. Generally, the steps of the method 300 provide techniques to determine that a customer's physical appearance has changed, and in response, target advertisements to the user that are related to the change in appearance. In at least one aspect, the advertisement application 212 performs the steps of the method 300. At step 310, the advertisement application 212 may receive a first image of a customer. For example, while checking out at a self-checkout lane (or kiosk) in a retail store on May 2^{nd}, the user may be asked to take a photo for that can be associated with the customer's loyalty (or rewards) account. The advertisement application 212 may then store the image in the profiles 209 and associate the image with the customer. At step 320, the advertisement application 212 may extract physical attributes from the image, and store the extracted physical attributes in the profiles 209. For example, the advertisement application 212 may determine that the user has wrinkled skin, is showing signs of baldness, and has an estimated 15% body fat percentage. The advertisement application 212 may then store these attributes in the profiles 209.

At step 330, the advertisement application 212 may receive a second image of the customer at a later time. The advertisement application 212 may generally include a predefined timing schedule that specifies intervals at which the customer should be prompted to provide another photograph. The advertisement application 212 may specify any interval, such as one month, six months, or one year. Therefore, continuing with the above example, the advertisement application 212 may prompt the customer to take a photo on December 6^{th}, which may be the customer's first visit to the retail store after the six month interval for updating photographs. Generally, the advertisement application 212 may receive images from of the user in any way, such as directly from the user via a portal to upload or share images. Once the image is received, the advertisement application 212 may store the image in the customer's user profile. At step 340, the advertisement application 212 may extract physical attributes from the second image, and store the extracted attributes in the profiles 209. For example, the advertisement application 212 may extract attributes from the December 6^{th} photo indicating the customer has lost even more hair, has healthier skin, and now has an estimated body fat percentage of 10%.

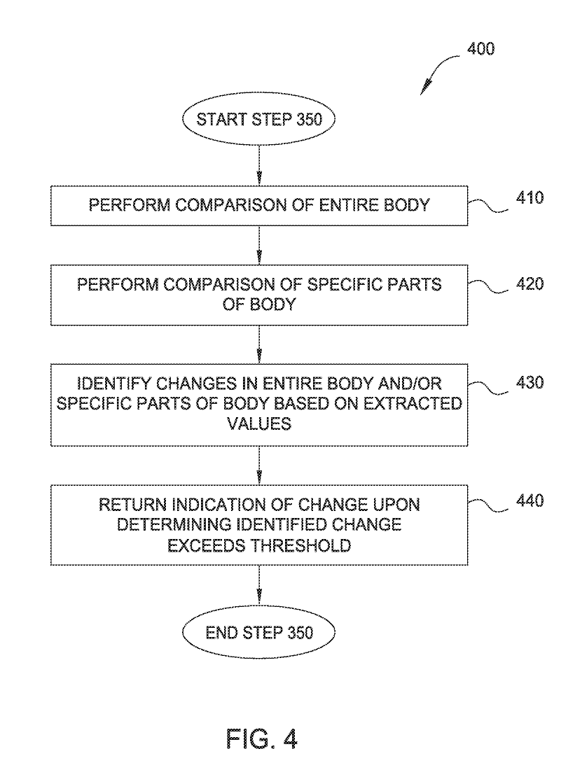

At step 350, described in greater detail with reference to FIG. 4, the advertisement application 212 may compare the extracted physical attributes the first and second images in order to detect a change in one or more physical attributes of the customer. For example, the advertisement application 212 may determine that the customer's photos indicate that the user has lost more, hair, lost weight, and no longer has wrinkled skin. Similarly, the advertisement application 212 may compare the two images in order to determine that the customer's physical appearance has undergone changes. Generally, the advertisement application 212 may detect any physical change of the user, such as whether the user is now in a wheelchair, gained weight, broke an arm, and the like. At step 360, the advertisement application 212 may select a targeted advertisement for the customer based on the physical change detected at step 350. For example, for the customer who has lost more hair, the advertisement application 212 may reference the advertisements 210 to find an advertisement associated with hair loss. Similarly, the advertisement application 212 may determine that because the customer has lost weight, advertisements for products to further the customer's healthy lifestyle may be selected. At step 370, the advertisement application 212 may send the selected advertisement to the customer. The advertisement application 212 may use any medium to transmit the advertisement, such as email, text messages, snail mail, and the like.

Although the steps of the method 300 are directed towards changes in physical attributes, other detected changes may also trigger targeted advertisements. For example, changes in address, marital status, shopping habits, and the like may trigger targeted advertisements.

FIG. 4 illustrates a method 400 corresponding to step 350 to detect changes in physical attributes, according to one aspect. Generally, the advertisement application 212 may perform the steps of the method 400 in order to determine that a customer has undergone a change in physical appearance. At step 410, the advertisement application 212 may perform a comparison of the customer's entire body in order to detect changes that affect the whole body, such as a substantial increase in body fat percentage (instead of a pregnancy, where weight gain may be largely isolated to the stomach region). The advertisement application 212 may perform the comparison of the entire body by comparing extracted values from all parts of the body in the profiles 209, or by comparing images of the customer.

At step 420, the advertisement application 212 may perform a comparison on specific parts of the body, such as teeth, hair, skin, and the like. The advertisement application 212 may perform the comparison of specific body parts (or regions) by comparing extracted values for specific parts of the body in the profiles 209. At step 430, the advertisement application 212 may identify changes in the customer's entire body and/or specific parts of the body based on the extracted values in the profiles 209 (or by performing an image comparison). At step 430, the advertisement application 212 may return an indication of a change in physical attributes upon determining the identified change exceeds a threshold specified in the comparison rules 211. For example, if the customer's estimated body fat percentage has increased by 1% in the last six months, and the comparison rules 211 require a 3% change in order to determine that the user's physical appearance has changed, the advertisement application 212 may determine that the 1% gain is not enough to trigger a targeted advertisement for weight loss products. However, if the change in body fat was 4%, then the advertisement application 212 may determine that the user has gained weight, and should be targeted with advertisements for weight loss products.

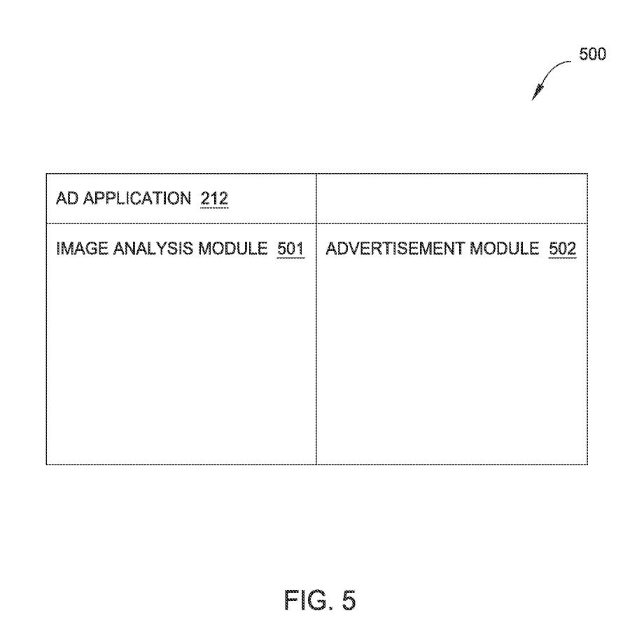

FIG. 5 illustrates components of the advertisement application 212, according to one aspect. As shown, the advertisement application 212 includes an image analysis module 501 and an advertisement module 502. Generally, the image analysis module 501 is configured to perform image analysis and comparison. The image analysis module 501 may implement any suitable algorithm to compare images or extract attributes therefrom. For example, the image analysis module 501 may implement one or more of keypoint matching, histogram matching, or keypoints using decision trees. By analyzing two images, the image analysis module 501 may extract attributes of a person's physical appearance, such as eye color, body fat percentage, hair thickness or density, hair color, and the like, and store the attributes in the profiles 209. Similarly, the image analysis module 501 may compare two images in order to identify physical changes in a user's appearance between the two images, and store an indication of the changes in the user's appearance in the profiles 209. The advertisement module 502 is generally configured to identify appropriate advertisements in the advertisements 210 based on detected changes in a customer's physical attributes. The advertisement module 502 may further cause the advertisements to be sent to the customer via any communications medium, such as email, telephone calls, and the like.

Advantageously, aspects disclosed herein target advertisements to customers based on changes in the customers' physical appearance. By tailoring advertisements to the specific needs of a customer, aspects disclosed herein may encourage more loyalty customers to shop with a retailer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the foregoing, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the advertisement application 212 may execute on a computing system in the cloud and process images of users. In such a case, the application 212 could extract physical attributes of the user and store indications of changes in the user's physical attributes at a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
performing image analysis of a first image and a second image by operation of one or more computer processors, wherein performing the image analysis comprises:
comparing a first physical trait of a person in the first image to the first physical trait of the person in the second image, wherein the first image was taken earlier in time than the second image; and
detecting, based on the comparison, a change in the first physical trait of the person; and
preparing a targeted advertisement directed to the person based on the change in the first physical trait.

2. The method of claim 1, wherein detecting the change comprises determining that a first value quantifying the first physical trait in the first image and a second value quantifying the first physical trait in the second image has a difference exceeding a predefined threshold for the first physical trait.

3. The method of claim 1, wherein the first and second images of the person are captured at a checkout lane of a retail establishment.

4. The method of claim 1, wherein detecting comprises:
extracting values for a set of physical traits of the person from the first image, wherein the set of physical traits includes the first physical trait;
extracting updated values for the set of physical traits from the second image; and
comparing the updated values to the extracted values to detect the change in the first physical trait.

5. The method of claim 1, wherein the targeted advertisement is transmitted via one or more of: (i) an email, (ii) a mailing, (iii) a text message, (iv) a multimedia message, and (v) a social media message.

6. The method of claim 1, wherein the targeted advertisement specifies a product related to the change in the physical trait.

7. The method of claim 1, wherein the physical trait comprises at least one of: (i) a weight of the person, (ii) an amount of hair on a head of the person, (iii) a degree of yellow coloration on the teeth of the person, (iv) a pregnancy status of the person, and (v) a set of eyeglasses worn by the person.

8. A computer program product, comprising:
computer readable program code, which when executed by a processor, performs an operation comprising:
performing image analysis of a first image and a second image, wherein performing the image analysis comprises:
comparing a first physical trait of a person in the first image to the first physical trait of the person in the second image, wherein the first image was taken earlier in time than the second image; and
detecting, based on the comparison, a change in the first physical trait of the person; and
preparing a targeted advertisement directed to the person based on the change in the first physical trait.

9. The computer program product of claim 8, wherein detecting the change comprises determining that a first value quantifying the first physical trait in the first image and a second value quantifying the first physical trait in the second image has a difference exceeding a predefined threshold for the first physical trait.

10. The computer program product of claim 8, wherein the first and second images of the person are captured at a checkout lane of a retail establishment.

11. The computer program product of claim 8, wherein detecting comprises:
extracting values for a set of physical traits of the person from the first image, wherein the set of physical traits includes the first physical trait;
extracting updated values for the set of physical traits from the second image; and
comparing the updated values to the extracted values to detect the change in the first physical trait.

12. The computer program product of claim 8, wherein the targeted advertisement is transmitted via one or more of: (i) an email, (ii) a mailing, (iii) a text message, (iv) a multimedia message, and (v) a social media message.

13. The computer program product of claim 8, wherein the targeted advertisement specifies a product related to the change in the physical trait.

14. The computer program product of claim 8, wherein the physical trait comprises at least one of: (i) a weight of the person, (ii) an amount of hair on a head of the person, (iii) a degree of yellow coloration on the teeth of the person, (iv) a pregnancy status of the person, and (v) a set of eyeglasses worn by the person.

15. A system, comprising:
a computer processor; and
a memory containing a program which when executed by the processor performs an operation comprising:
performing image analysis of a first image and a second image, wherein performing the image analysis comprises:
comparing a first physical trait of a person in the first image to the first physical trait of the person in the second image, wherein the first image was taken earlier in time than the second image; and
detecting, based on the comparison, a change in the first physical trait of the person; and
preparing a targeted advertisement directed to the person based on the change in the first physical trait.

16. The system of claim 15, wherein detecting the change comprises determining that a first value quantifying the first physical trait in the first image and a second value quantifying the first physical trait in the second image has a difference exceeding a predefined threshold for the first physical trait.

17. The system of claim 15, wherein the first and second images of the person are captured at a checkout lane of a retail establishment.

18. The system of claim 15, wherein detecting comprises:
extracting values for a set of physical traits of the person from the first image, wherein the set of physical traits includes the first physical trait;
extracting updated values for the set of physical traits from the second image; and
comparing the updated values to the extracted values to detect the change in the first physical trait.

19. The system of claim 15, wherein the targeted advertisement is transmitted via one or more of: (i) an email, (ii) a mailing, (iii) a text message, (iv) a multimedia message, and (v) a social media message.

20. The system of claim 15, wherein the targeted advertisement specifies a product related to the change in the physical trait, wherein the physical trait comprises at least one of: (i) a weight of the person, (ii) an amount of hair on a head of the person, (iii) a degree of yellow coloration on the teeth of the person, (iv) a pregnancy status of the person, and (v) a set of eyeglasses worn by the person.
